(19) United States
(12) Patent Application Publication
(10) Pub. No.: US 2009/0184485 A1
(43) Pub. Date: Jul. 23, 2009

(54) Vehicle Running Board Assembly

(75) Inventors: Brian V. Castillo, Royal Oak, MI (US); Robert E. Zeweke, Shelby Township, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/017,420

(22) Filed: Jan. 22, 2008

(51) Int. Cl. B60R 3/00; B60R 19/42

(52) U.S. Cl. 280/164.1; 296/193.05; 293/126

(57) ABSTRACT

A running board assembly is provided that has structural tubing mounted to one of the spaced, longitudinally-extending frame rails. The structural tubing is configured to bear side impact loads in part by providing a continuous load-bearing path to direct the load to the frame rail. Additionally, because the structural tubing is of a higher strength than materials typically used for running boards, the structural tubing itself absorbs some of the side impact load.

### TECHNICAL FIELD

The invention relates to a vehicle running board assembly mounted to a vehicle frame rail.

### BACKGROUND OF THE INVENTION

To assist in entering and exiting the passenger compartment, pickup trucks and SUVs may be outfitted with side platforms or “running boards” that extend lengthwise beneath and alongside the passenger compartment of the vehicle at a position adjacent to the passenger doors in order to provide a convenient step surface. Running boards may be relatively flat, board-like surfaces, or may be tubular, serving the same function, but offering a different aesthetic look and appeal. Running boards are typically secured to sheet metal rocker panel assemblies that run longitudinally under the passenger doors. Running boards are generally constructed from various materials, such as stainless steel, chrome, brushed metal, and/or injection-molded plastics and are designed to be sturdy enough to support the weight of a vehicle user standing on the running board while not unnecessarily adding additional weight to the vehicle. Thus, in a side impact situation, energy absorption by the running board is limited, as neither the running board nor the rocker assemblies are typically designed to perform the side impact energy absorption functions performed by structural members such as the frame.

### SUMMARY OF THE INVENTION

A running board assembly is provided that has structural tubing mounted to a longitudinally-extending frame rail. The structural tubing is configured to bear side impact loads in part by providing a continuous load-bearing path to direct the load to the frame rail. Additionally, because the structural tubing is of a higher strength than materials typically used for running boards, the structural tubing itself absorbs some of the side impact load. As used herein, “structural tubing” is tubing having adequate wall thickness, material properties, and section geometry to enable the transmission of loads similar in magnitude to those capable of being borne by frame members in an impact event, as opposed to non-structural elements, which are not designed to withstand such loading and will fail at loads significantly below those capable of being borne by the frame. For example, structural tubing with a 2.5 inch diameter and 0.125 inch wall thickness would be of adequate load-bearing ability. As used herein “running board” and “running board assembly” is not limited to embodiments with a flat, board-like stepping member, but instead includes those with structural tubing, and may alternately be referred to as a stepping member and a stepping member assembly.

More specifically, the structural tubing may include a first structural tubing portion that is generally perpendicular to the frame rail. This first structural tubing portion may be laterally-aligned with a cross member, such as a transmission support, that spans the space between the frame rail and another longitudinally-extending frame rail, and is rigidly attached to both frame rails. Thus, the first structural tubing portion, the frame rail and the cross member at least partially define a load-bearing path for side impact loads.

In some embodiments, the first structural tubing portion is mounted to the frame rail via a closed-section mounting member, which also forms part of the continuous load-bearing path. The first structural tubing portion is welded or otherwise rigidly secured (e.g., by bolts) to the mounting member. The closed-section mounting member is welded or otherwise rigidly secured (e.g., by bolts) to the frame rail. As used herein, “closed-section” means that the mounting member is substantially continuous in a cross-section taken laterally therethrough where the first structural tubing portion mounts to the mounting member.

The structural tubing may also have a second structural tubing portion extending longitudinally and secured to a laterally outward end of the first structural tubing portion so that it is spaced from one of the frame rails by the first structural tubing portion. If a like running board assembly is secured to the other frame rail via a like mounting member, the running board assemblies, mounting members, frame rails and cross-member form a side impact assembly with a continuous load-bearing path formed from an outer extremity (i.e., a laterally outboard extremity) of the second structural tubing portion of one of the running board assemblies to an outer extremity of the second structural tubing portion of the other running board assembly.

The second structural tubing portion may have inwardly-extending end portions spaced forward and rearward of the first structural tubing portion and also rigidly connected to the same frame rail that the first structural tubing portion is connected to, preferably by like, closed-section mounting members. A trim member may be secured to an upward-facing surface (i.e., a stepping surface) of the second structural tubing portion. Additionally, the second structural tubing portion may be cylindrical or non-cylindrical in a lateral cross-section. A non-cylindrical second structural tubing portion may be configured to provide a generally flat stepping surface.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic plan view illustration of a vehicle with a first embodiment of running board assemblies mounted to two longitudinal frame rails;

FIG. 2 is a schematic cross-sectional fragmentary view of the vehicle of FIG. 1 taken at the lines 2-2 in FIG. 1;

FIG. 3 is a schematic perspective illustration of one of the running board assemblies of FIG. 1 having cylindrical structural tubing;

FIG. 4 is a side cross-sectional view of a first alternative embodiment of a running board assembly with non-cylindrical structural tubing;

FIG. 5 is a side cross-sectional view of a second alternative embodiment of a running board assembly with non-cylindrical structural tubing; and

FIG. 6 is a side cross-sectional view of a third alternative embodiment of a running board assembly with non-cylindrical structural tubing.

### DESCRIPTION OF THE PREFERRED EMBODIMENTS

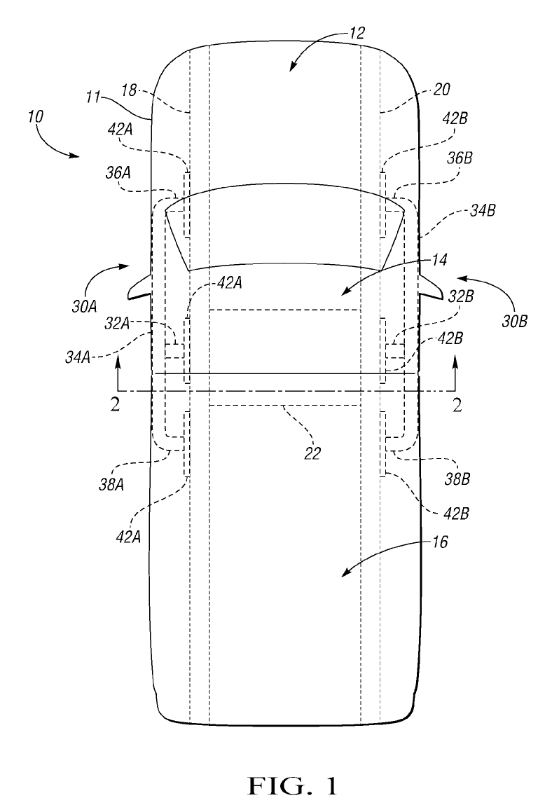

Referring to the drawings, wherein like reference numbers refer to like components, FIG. 1 shows a vehicle 10. In this embodiment, the vehicle 10 is represented generally by a vehicle body 11 that is of a pickup-type. The body 11 defines an engine compartment 12, a passenger compartment or cab portion 14, and a bed 16. However, a variety of other types of vehicles may be used within the scope of the invention, including sport utility vehicles and trucks.

The vehicle 10 has longitudinally-extending (i.e., running fore and aft) frame rails 18, 20. The frame rails 18, 20 are of a structural, load-bearing material, such as structural steel, and are connected to other frame components (not shown) to add structural integrity to the vehicle. The frame rails 18, 20 may each be a unitary component, formed by hydro-forming or another method, or may have separate inner and outer members welded or otherwise secured to one another.

A transmission cross-member 22 spans the lateral space between the frame rails 18, 20 (i.e., inboard of the frame rails 18, 20), and is rigidly connected to and supported by the frame rails 18, 20. As shown in FIG. 2, the cross member 22 is bolted to each of the frame rails 18, 20 with bolts 24 and forms a cradle to support a transmission (not shown) in the space 26 between the cross member 22 and a floor assembly 28. Sheet metal rocker assemblies 27A, 27B are secured to the floor assembly 28 and run generally fore and aft. Door assemblies 29A, 29B, also formed of sheet metal, fiberglass or the like, interfit with the rocker assemblies 27A, 27B and other frame pillars, such as A-pillars and B-pillars (not shown), as is readily understood by those skilled in the art. The vehicle body 11 is connected to the vehicle frame rails 18, 20 via tabs welded to the frame rails. A threaded fastener passes through each tab to connect the frame rails 18, 20 to the body 11. Elastomeric bushings are positioned between the tabs and the body 11 to isolate the body 11 from the tabs. The tabs, bushings and fasteners are not shown in the cross-section of FIG. 2, but are known and will be understood by those skilled in the art, and are most likely located forward or rearward of the mounting members 42A, 42B, shown and discussed below with respect to FIG. 2. FIG. 2 is a schematic partial cross-sectional view, showing only a portion of the vehicle 10 from a lower portion of the door assemblies 29A, 29B and below.

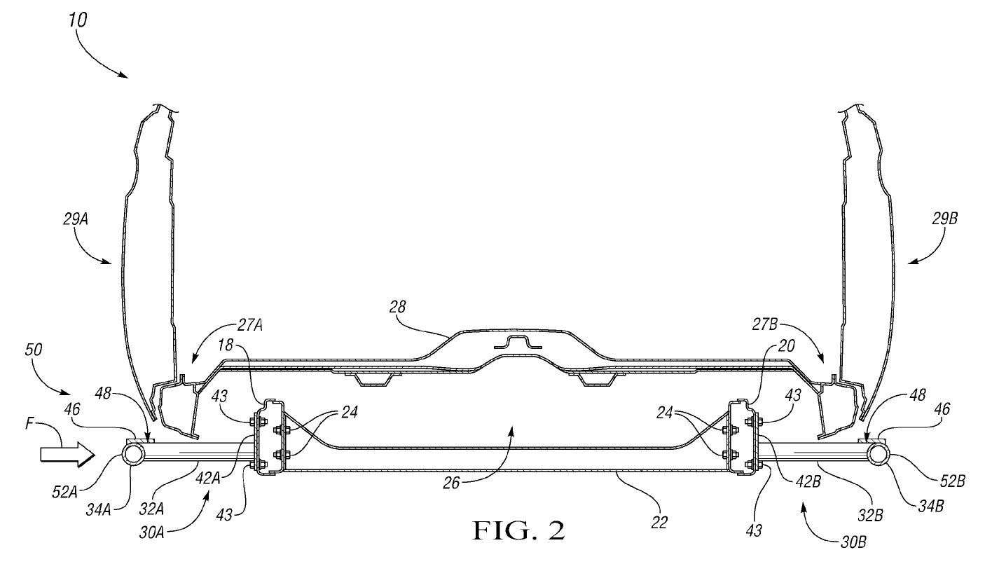

Running board assemblies 30A, 30B are rigidly connected to the respective frame rails 18, 20. As best viewed in FIGS. 1 and 3, running board assembly 30A is structural tubing including a first tubing portion 32A that is generally perpendicular to the frame rail 18. Likewise, running board assembly 30B is structural tubing including first tubing portion 32B that is generally perpendicular to frame rail 20. A respective second tubing portion 34A, 34B extends longitudinally and is secured to the first tubing portions 32A, 32B outboard thereof by welding or other means. The second tubing portions 34A, 34B are each formed with inwardly curved end portions 36A forward of the first tubing portions 32A and inwardly curved end portions 38A rearward of the first tubing portions 32A, 32B. End portions 36A and 38A are shown only with respect to second tubing portion 34A in FIG. 3; second tubing portion 34B has substantially identical end portions 36B, 38B, as illustrated in FIG. 1.

An inboard end 40A, 40B (see FIG. 2) of the first tubing portions 32A, 32B, and inboard ends of the end portions 36A, 36B, 38A, 38B (see FIG. 1) are welded or otherwise secured to respective rigid closed-section mounting members 42A, 42B, also referred to as stanchions. As used herein, “closed-section” means that the mounting members 42A, 42B are solid structural steel in cross-sectional view. In this embodiment, the mounting members 42A, 42B are steel plates bolted to the respective frame rails 18, 20 laterally outboard thereof with bolts 43 (shown in FIG. 1) extending through bolt openings 44 (shown in FIG. 2) aligned with corresponding openings in the frame rails 18, 20. A trim member 46 is secured to an upward-facing surface 48 (i.e., a stepping surface) of the second structural tubing portion 34A (and a like trim member 46 is secured to second structural tubing portion 34B as shown in FIG. 2). The trim members 46 may be plastic or of any other material suitable for enhancing traction at the surface 48 and/or to meet desired styling. For example, the trim members may be more extensive, and may extend inward toward the mounting member 42A to provide a larger stepping area, similar to typically, flat running boards. The respective first and second tubular portions 32A, 34A and 32B, 34B may be referred to as running boards. The running board assemblies 30A, 30B include the first and second tubular portions 32A, 34A and 32B, 34B (i.e., the running boards), the trim members 46 (if provided), and the mounting members 42A, 42B, respectively.

Referring again to FIGS. 1 and 2, the cross member 22 is longitudinally (fore and aft; see FIG. 1) and laterally (sideways, at overlapping elevations; see FIG. 2) aligned with the running board assemblies 30A, 30B. Thus, from an outer extremity 52A of running board assembly 30A to an outer extremity 52B of running board assembly 30B, a side impact assembly 50 is formed by the assembled running board assemblies 30A, 30B (including the first and second tubular portions 32A, 34A and 32B, 34B, the trim members 46 (if provided), the mounting members 42A, 42B, frame rails 18, and cross member 22) that forms a continuous load-bearing path when subjected to a side impact force F. Accordingly, the impacting force F will be transferred to the frame rails 18, 20 and the cross member 22 to begin energy dissipation as soon as the force F contacts the outer extremity 52A. Laterally inward deformation of either of the door assemblies 29A, 29B and/or rocker assemblies 27A, 27B due to the side impact force F should be mitigated by the energy absorption of the more rigid side impact assembly 50 with its greater energy absorbing capability.

FIGS. 4-6 illustrate alternative embodiments of running board assemblies, and particularly the running board structural tubing portions thereof any of which may be used on vehicle 10 of FIGS. 1 and 2 in lieu of running board assembly 130A with a like, symmetrical running board assembly also used in lieu of running board assembly 130B. Referring to FIG. 4, a running board assembly 130 is illustrated. Running board assembly 130 includes a first structural tubing portion 132 secured at one end to a mounting member 42A (such as by bolts or welding) and secured at an opposing end to a second structural tubing portion 134. (Note that second structural tubing portion 134 has inwardly curved end portions (not shown) that would be secured at additional mounting members 42A to the frame rail 18.) At least a portion of the second structural tubing portion 134 is non-cylindrical and elongated in cross-section and provides a generally flat stepping surface 148 on which trim member 146 is secured.

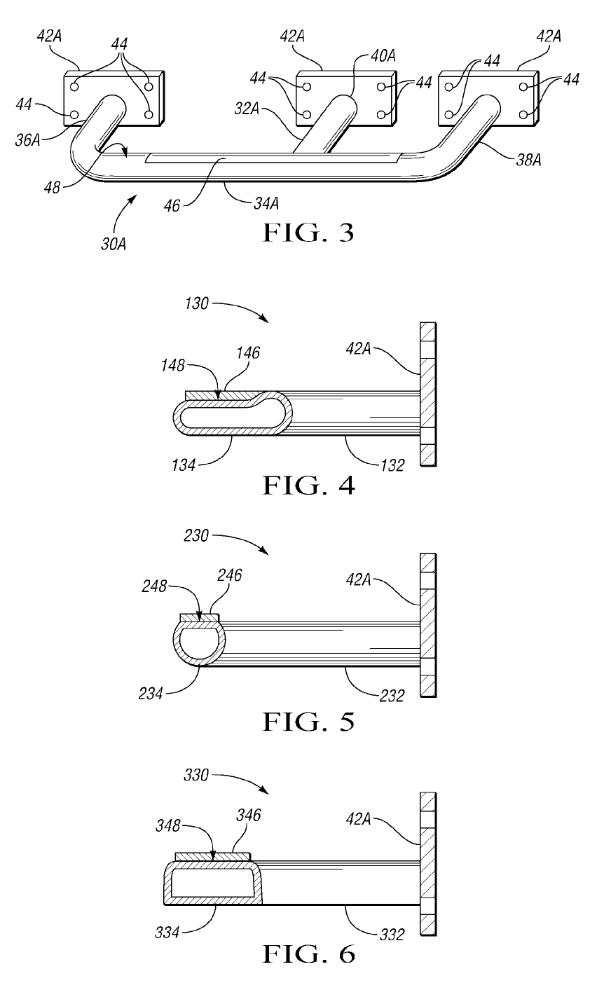

Referring to FIG. 5, running board assembly 230 includes a first structural tubing portion 232 secured at one end to a mounting member 42A (such as by bolts or welding) and secured at an opposing end to a second structural tubing portion 234. (Note that second structural tubing portion 234 has inwardly curved end portions (not shown) that would be secured at additional mounting members 42A to the frame rail 18.) The second structural tubing portion 234 is non-cylindrical in cross-section and provides a generally flat stepping surface 248 on which trim member 246 is secured.

Referring to FIG. 6, running board assembly 330 includes a first structural tubing portion 332 secured at one end to a mounting member 42A (such as by bolts or welding) and secured at an opposing end to a second structural tubing portion 334. (Note that second structural tubing portion 334 has inwardly curved end portions (not shown) that would be secured at additional mounting members 42A to the frame rail 18.) The second structural tubing portion 334 is non-cylindrical and elongated in cross-section and provides a generally flat stepping surface 348 on which trim member 346 is secured.

While the best modes for carrying out the invention have been described in detail, those familiar with the art to which this invention relates will recognize various alternative designs and embodiments for practicing the invention within the scope of the appended claims.

1. An apparatus for a vehicle having spaced, longitudinally-extending frame rails, comprising:
a running board assembly having structural tubing mounted to one of the frame rails and configured to bear side impact loads.

2. The apparatus of claim 1, wherein a portion of the structural tubing rigidly mounted to the one of the frame rails is generally perpendicular to the one of the frame rails.

3. The apparatus of claim 2, wherein the vehicle has a load-bearing cross member connecting the spaced, longitudinally-extending frame rails; and wherein the portion of the structural tubing is aligned laterally with the load-bearing cross member so that the portion of the structural tubing, the frame rails and the cross member at least partially define a continuous load-bearing path for side impact loads.

4. The apparatus of claim 1, wherein the running board assembly includes a rigid closed-section mounting member attached to the one of the frame rails; and wherein the portion of the structural tubing is mounted to the one of the frame rails via the mounting member.

5. The apparatus of claim 4, wherein the portion of the structural tubing is welded to the rigid closed-section mounting member; and wherein the rigid closed-section mounting member is bolted to the one of the frame rails.

6. The apparatus of claim 1, wherein the portion of the structural tubing is a first structural tubing portion; and wherein the running board assembly has a second structural tubing portion extending longitudinally, spaced from the one of the frame rails outboard of the first structural tubing portion and connected to the first tubular portion.

7. The apparatus of claim 6, wherein the second structural tubing portion has end portions that are longitudinally-spaced forward and rearward of the first structural tubing portion; and wherein the end portions are rigidly connected to the one of the frame rails.

8. The apparatus of claim 7, wherein the running board assembly further includes additional rigid closed-section mounting members attached to the one of the frame rails; and wherein the end portions are mounted to the one of the frame rails via the additional rigid closed-section mounting members.

9. The apparatus of claim 1, wherein the running board assembly further includes a trim member secured to an upward-facing surface of the second structural tubing portion.

10. A vehicle comprising:
spaced, longitudinally-extending frame rails; and
a running board assembly rigidly mounted to one of the frame rails and extending outboard therefrom to bear side impact loads.

11. The vehicle of claim 10, wherein at least a portion of the running board assembly is structural tubing.

12. The vehicle of claim 11, wherein at least a portion of the structural tubing is not cylindrical and provides a generally flat stepping surface.

13. The vehicle of claim 12, wherein the running board assembly further includes a rigid closed-section mounting member attached to the one of the frame rails; and wherein the portion of the structural tubing is mounted to the one of the frame rails via the mounting member.

14. The vehicle of claim 10, wherein the vehicle has a structural cross member rigidly connecting the frame rails inboard of the frame rails, and wherein the running board assembly is aligned both longitudinally and laterally with the structural cross member.

15. A side impact assembly for a vehicle:
a first and a second longitudinally-extending frame rail laterally spaced from one another;
a cross member extending laterally and connecting the frame rails;
a first and a second rigid closed-section mounting member attached to the first and the second frame rail, respectively; and
a first and a second running board formed of structural tubing and mounted to the first and second frame rail, respectively, to extend outboard thereof at the first and second rigid closed-section mounting members, respectively; the side impact assembly thereby providing continuous side impact load-bearing structure from an outboard extremity of the first running board to an outboard extremity of the second running board.
